(19) United States
(12) Patent Application Publication
(10) Pub. No.: US 2009/0284418 A1
(43) Pub. Date: Nov. 19, 2009

(54) MULTIBAND ANTENNA

(75) Inventor: YEN-YI SHIH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/211,032

(22) Filed: Sep. 15, 2008

(30) Foreign Application Priority Data
May 16, 2008 (TW) 97118011

(51) Int. Cl. H01Q 1/38

(52) U.S. Cl. 343/700 MS

(57) ABSTRACT

A multiband antenna is positioned on a substrate and includes a feeding portion, a grounding portion, and a radiating portion. The feeding portion is configured for feeding electromagnetic signals. The grounding portion is positioned on the substrate. The radiating portion electrically connects to the feeding portion for transceiving the electromagnetic signals. The radiation portion includes a first radiator and a second radiator. The first radiator includes a first radiating section that electrically connects to the feeding portion, a second radiating section, and a third radiating section, all of which electrically connects one another one-by-one in sequence and cooperatively defines a receiving space. The second radiator is housed in the receiving space and electrically connects to the feeding portion.

### BACKGROUND

1. Field of the Invention

Embodiments of the present disclosure relate to antennas, and particularly, to a multiband antenna.

2. Description of Related Art

With recent developments in wireless communication technologies, wireless communication devices are now in widespread use. High performance wireless communication devices that are compact are especially in demand. Antennas are essential components in wireless communication devices for radiating electromagnetic signals.

Currently, a challenge exists in being able to design compact antennas that operate in the frequency bands of Global System for Mobile communication (GSM), Distributed Control System (DCS), Personal Communication Service (PCS), and Wideband-Code Division Multiple Access (W-CDMA).

### SUMMARY

An exemplary embodiment of the present disclosure provides a multiband antenna. The multiband antenna is positioned on a substrate and includes a feeding portion, a grounding portion, and a radiating portion. The feeding portion is configured for feeding electromagnetic signals. The grounding portion is positioned on the substrate. The radiating portion electrically connects to the feeding portion for transceiving the electromagnetic signals. The radiation portion includes a first radiator and a second radiator. The first radiator includes a first radiating section that electrically connects to the feeding portion, a second radiating section, and a third radiating section, all of which electrically connects one another one-by-one in sequence and cooperatively defines a receiving space. The second radiator is housed in the receiving space and electrically connects to the feeding portion.

Other advantages and novel features of the present disclosure will become more apparent from the following detailed description of certain inventive embodiment when taken in conjunction with the accompanying drawings, in which:

### BRIEF DESCRIPTION OF THE DRAWINGS

FIG. 1 is a plan view of a multiband antenna in accordance with one embodiment of the present disclosure;

FIG. 2 is a solid schematic diagram of a multiband antenna in accordance with another embodiment of the present disclosure;

FIG. 3 is a graph showing one embodiment of a voltage standing wave ratio (VSWR) of the multiband antenna of FIG. 1; and

FIG. 4 is a Smith chart of the multiband antenna of FIG. 1.

### DETAILED DESCRIPTION

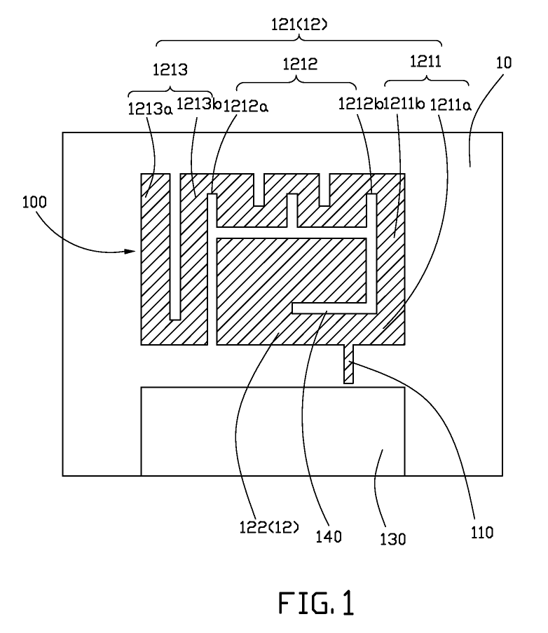

FIG. 1 is a plan view of a multiband antenna 100 in accordance with one embodiment of the present disclosure. The multiband antenna 100 is positioned on a substrate 10 and includes a feeding portion 110, a grounding portion 130 and a radiating portion 12. The feeding portion 110 is configured for feeding electromagnetic signals. The radiating portion 12 electrically connects to the feeding portion 110 for transceiving the electromagnetic signals. The radiating portion 12 comprises a zigzag shape and includes L, S, W and U shapes, wherein each of the S, W, a n d U shapes extend along at least a portion of the radiating portion 12. The radiation portion 12 includes a first radiator 121 and a second radiator 122. The first radiator 121 includes a first radiating section 1211, a second radiating section 1212, a n d a third radiating section 1213 that electrically connecting one another one-by-one in sequence. In one embodiment, the first radiating section 1211 has an L-shape configuration, the second radiating section 1212 has one or more S-shaped, W-shaped, and U-shaped configurations. The third radiating section 1213 has an U-shape configuration. The first radiating section 1211 electrically connects to the feeding portion 110. The first radiating section 1211, the second radiating section 1212, and the third radiating section 1213 cooperatively define a receiving space 140.

The first radiating section 1211 includes a first radiating segment 1211a and a second radiating segment 1211b connecting to the first radiating segment 1211 a orthogonally. The first radiating segment 1211a and the second radiating segment 1211b cooperatively form a L-shape. The first radiating segment 1211a connects to the feeding portion 110 and the second radiating segment 1211b electrically connects to one end 1212b of the second radiating section 1212.

The third radiating section 1213 includes a third radiating segment 1213a and a fourth radiating segment 1213b parallel to the third radiating segment 1213a. The third radiating segment 1213a comprises a free end that is not connected any other segments. The fourth radiating segment 1213b electrically connects to the other end 1212a of the second radiating section 1212.

The second radiator 122 is housed in the receiving space 140 defined by the first radiator 121. In one embodiment, the second radiator 122 is U-shaped and comprises one side that electrically connects to the feeding portion 110, and another side comprising a free end. In other embodiments, the second radiator 122 may be L-shaped, S-shaped, W-shaped, etc. In one embodiment, the feeding portion 110, the first radiator 121, the second radiator 122, and the grounding portion 130 are printed on the substrate 10.

Due to the bent configuration formed by the first radiating section 1211, the second radiating section 1212, and the third radiating section 1213, the dimensions of the first radiator 121 are reduced. The first radiator 121 and the second radiator 122 are spaced apart from each other, which can produce coupling effects.

The multiband antenna 100 may operate in the four frequency bands. In one embodiment, the four frequency bands include Global System for Mobile Communication (GSM), Distributed Control System (DCS), Personal Communication Service (PCS), and Wideband-Code Division Multiple Access (W-CDMA).

In one embodiment, the feeding portion 110, the first radiator 121, the second radiator 122, and the grounding portion 130 are printed on the substrate 10.

In one particular embodiment, an area of the multiband antenna 100 may be 20×28 millimeters (mm)\hat{0}2.

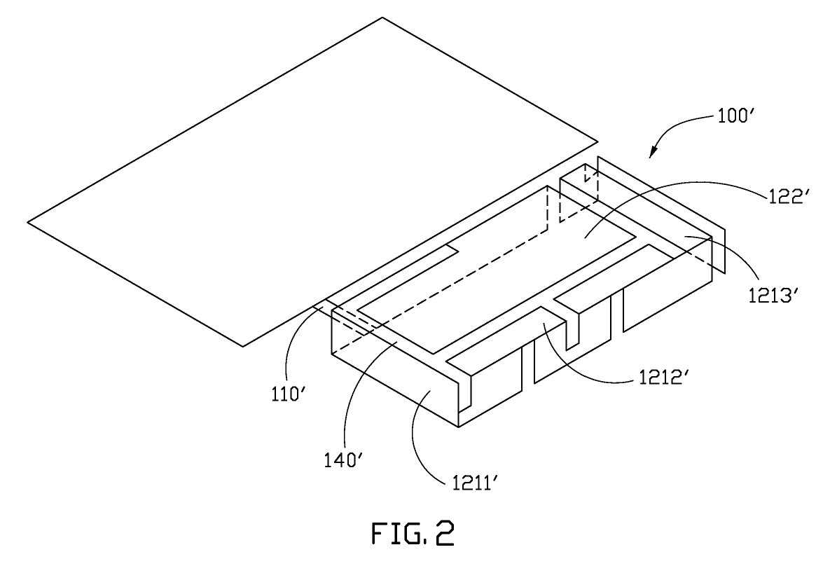

FIG. 2 is a solid schematic diagram of a multiband antenna 100′ in accordance with another embodiment of the present disclosure. In one embodiment, the multiband antenna 100′ is formed by bending the multiband antenna 100 in FIG. 1. The dimensions of multiband antenna 100′ may be 15×19×3 mm\hat{0}3 in one particular embodiment.

The multiband antenna 100 and the multiband antenna 100′ can operate in the four frequency bands previously mentioned. Additionally, the widths of the multiband antenna 100 and the multiband antenna 100′ may be less than 30 mm, which makes them compatible with a Peripheral Component Interconnection (PCI) architecture.

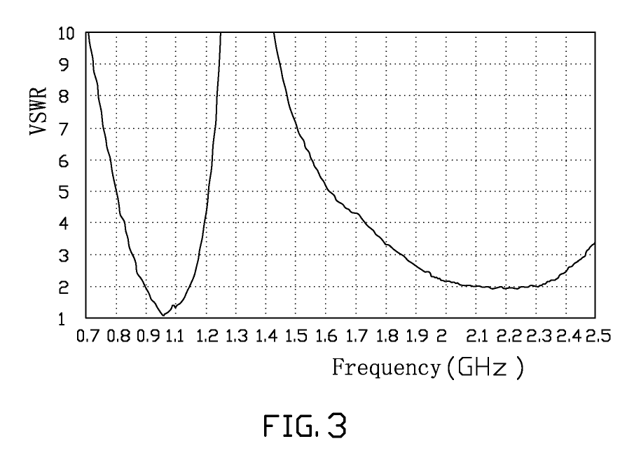

FIG. 3 is a graph showing one embodiment of a voltage standing wave ratio (VSWR) of the multiband antenna 100 of FIG. 1. As shown, when the multiband antenna 100 operates in the frequency band of 0.882 GHz, the VSWR is approximately 2.23. When the multiband antenna 100 operates in the frequency band of 0.960 GHz, the VSWR is approximately 1.09. When the multiband antenna 100 operates in the frequency band of 1.711 GHz, the VSWR is approximately 3.27. When the multiband antenna 100 operates in the frequency band of 2.202 GHz, the VSWR is approximately 1.99. As shown by the graph of FIG. 3, the VSWR is less than 3.5 when the multiband antenna 100 operates in the above frequency bands.

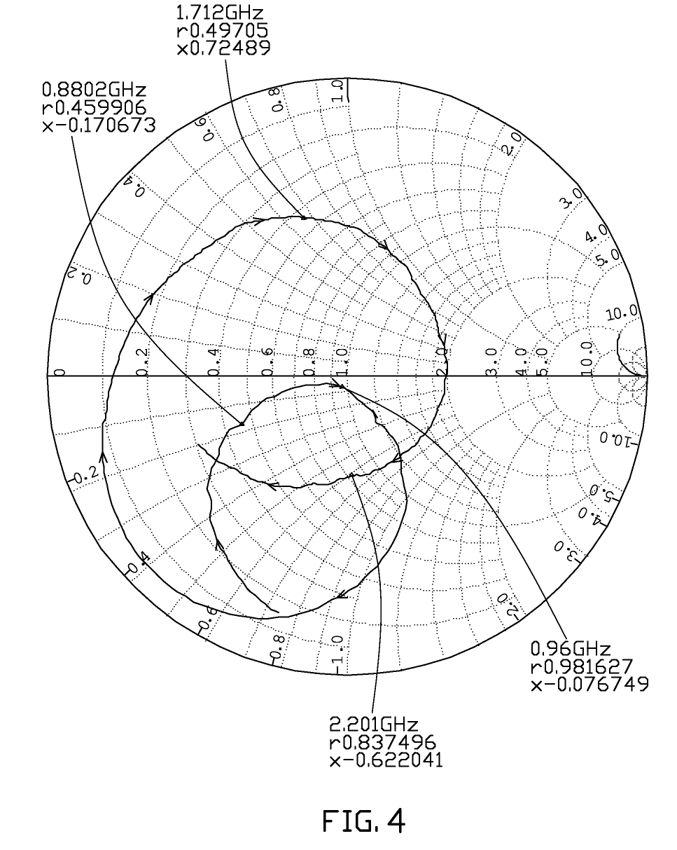

FIG. 4 is a Smith chart of the multiband antenna 100 of FIG. 1. It may be understood that a Smith chart may be used to graphically aid or plot radio frequencies when solving problems with transmission lines and matching circuits. As shown, when the multiband antenna 100 operates in the frequency band of 0.8802 GHz, the real part of the generalized impedance (r) is approximately 0.46 and the imaginary part of the generalized impedance (x) is approximately −0.17. When the multiband antenna 100 operates in the frequency band of 0.96 GHz, r is approximately 0.98 and x is −0.08. When the multiband antenna 100 operates in the frequency band of 1.712 GHz, r is approximately 0.50 and x is approximately 0.72. When the multiband antenna 100 operates in the frequency band of 2.201 GHz, r is approximately 0.84 and x is approximately −0.62.

The description of the present disclosure has been presented for purposes of illustration and description, and is not intended to be exhaustive or limited to the disclosure in the form disclosed. Many modifications and variations will be apparent to those of ordinary skill in the art. Various inventive embodiment were chosen and described in order to best explain the principles of the disclosure, the practical application, and to enable others of ordinary skill in the art to understand the disclosure for various embodiments with various modifications as are suited to the particular use contemplated.

What is claimed is:

1. A multiband antenna, positioned on a substrate, the multiband antenna comprising:
a feeding portion for feeding electromagnetic signals;
a grounding portion positioned on the substrate, and
a radiating portion electrically connecting to the feeding portion for transceiving the electromagnetic signals, the radiation portion comprising:
a first radiator comprising a first radiating section, a second radiating section, and a third radiating section electrically connecting one another one-by-one in sequence and cooperatively defining a receiving space, the first radiating section connecting to the feeding portion; and
a second radiator housed in the receiving space and electrically connecting to the feeding portion.

2. The multiband antenna as recited in claim 1, wherein the feeding portion, the grounding portion, and the radiating portion are printed on the substrate.

3. The multiband antenna as recited in claim 1, wherein the first radiating section comprises a first radiating segment connecting to the feeding portion and a second radiating segment connecting to the first radiating segment, wherein the second radiating segment is perpendicular to the first radiating segment.

4. The multiband antenna as recited in claim 1, wherein the second radiating section has one or more S-shaped, U-shaped, and W-shaped configurations, wherein the each of the S-shaped, U-shaped, and W-shaped configurations extend along at least a section of the second radiating section.

5. The multiband antenna as recited in claim 1, wherein the third radiator comprises a third radiating segment and a fourth radiating segment parallel to the third radiating segment, wherein the third radiating segment comprises a free end, and the fourth radiating segment electrically connects to the second radiating section.

6. A multiband antenna positioned on a substrate, comprising:
a feeding portion for feeding electromagnetic signals;
a grounding portion positioned on the substrate; and
a radiating portion electrically connecting to the feeding portion for transceiving the electromagnetic signals, and the radiating portion comprising:
a first radiator electrically connecting to the feeding portion, and comprising a plurality of radiating sections connecting one another one-by-one in sequence and cooperatively forming a receiving space; and
a second radiator housed in the receiving space and electrically connecting to the feeding portion.

7. The multiband antenna as recited in claim 6, wherein the radiating sections have one or more L-shaped, S-shaped, W-shaped or U-shaped configurations.

8. The multiband antenna as recited in claim 6, wherein the first radiator and the second radiator define a distance, which can produce coupling effects.

9. The multiband antenna as recited in claim 6, wherein the radiating portion is adapted to be bent to become a solid multiband antenna.
